(19) United States
(12) Patent Application Publication
(10) Pub. No.: US 2011/0309917 A1
(43) Pub. Date: Dec. 22, 2011

(54) AC POWER SUPPLY CIRCUITRY

(76) Inventor: Julian DAVIS, Bristol (GB)

(21) Appl. No.: 13/116,483

(22) Filed: May 26, 2011

(30) Foreign Application Priority Data
Jun. 17, 2010 (EP) 10166270.8

(51) Int. Cl. G05B 11/01

(52) U.S. Cl. 340/12.37

(57) ABSTRACT

AC power supply circuitry comprising an AC power source is provided. The circuitry further comprises a semiconductor switching device in an AC power line between the power source and an output and a switch that switches the semiconductor switching device between a first state in which it transmits power from the source to the output and a second state in which it does not transmit power to the output. The circuitry further comprises a diplexer that couples communications data on to the power line. Communications data is coupled on to the power line only if said semiconductor device is in said first state.

### BACKGROUND OF THE INVENTION

1. Field of the Invention

Embodiments of the present invention relate to the field of AC power supply circuitry.

2. Description of the Prior Art

AC power control using solid state circuitry is typically provided by the employment of solid state semiconductor based power switching devices such as triacs, back-to-back thyristors and insulated-gate bipolar transistors (IGBTs). Control is achieved by delaying the switching on of the device at each half cycle of the AC supply, so that only part of the AC supply waveform is applied to a load. The electrical pulses to the trigger electrode of the triac or thyristor or the gate of an IGBT are delayed by simple electronic circuitry, with a variable delay to provide variable power control. This is illustrated in FIG. 1, for a power controller feeding a simple resistive load. The circuit consists of an AC power source 1, which is connected via a solid state semiconductor based power switching device 2, in this case a triac, in an AC power line to a load 3. A variable delay to each trigger pulse from a control input to the triac 2 is provided by a simple electronic module 4. FIG. 2 shows the AC voltage waveform 5 of the power source 1 and the electrical trigger pulses 6 applied to the trigger electrode of the triac 2, each delayed in time from the zero crossing point of the voltage waveform 5 and generated by the electronic module 4, resulting in the truncated sine wave voltage waveform 7 across the load 3.

As can be seen from the waveform figures, there is a time interval from each zero crossing point of the power source waveform to the point where the triac 2 switches on, the time interval being variable via module 4. During each such interval (when triac 2 is in a state in which it does not transmit power to its output), the power supply is effectively disconnected from the load.

In some power supply applications, triacs, thyristors and IGBTs are simply used as switches, but even in these applications such a device cannot be switched on until the voltage waveform across it has risen by a few volts, so there are periods of time when the power supply is effectively disconnected from the load, even though they are shorter than in the case of devices used for variable AC power control.

For some systems, particularly for fluid extraction well complexes, the power line is also used as a data communication line by the coupling of communications data on to the AC power line, such a system being known as a communication on power (COP) system. In such a system, the “off periods” of a solid state semiconductor based power switching device result in corruption of the communications data. Consequently, current COP systems remove the communications data from the power line, upstream of the power switching device, and reintroduce the communications data to the power line downstream of the power switching device, at considerable expense, particularly if the power line is very high voltage. Embodiments of the present invention overcome the need to remove and reintroduce communications data in a COP system using a solid state semiconductor based power switching device.

### SUMMARY OF THE INVENTION

According to embodiments of the present invention, there is provided AC power supply circuitry comprising an AC power source. The circuitry further comprises a semiconductor switching device in an AC power line between the power source and an output and a switch that switches the semiconductor switching device between a first state in which it transmits power from the source to the output and a second state in which it does not transmit power to the output. The circuitry further comprises a diplexer that couples communications data on to the power line. Communications data is coupled on to the power line only if said semiconductor device is in said first state.

### BRIEF DESCRIPTION OF THE DRAWINGS

FIG. 1 shows schematically a known form of AC power control circuitry;

FIG. 2 shows waveforms appearing in the circuitry of FIG. 1;

FIG. 3 shows schematically an embodiment of AC power control circuitry according to an embodiment of the present invention; and

FIG. 4 is a block diagram of a system for supplying and transmitting AC power and communications data in a subsea fluid extraction well complex incorporating an embodiment of the present invention.

### DETAILED DESCRIPTION OF THE INVENTION

In the following embodiments, in a COP system with variable control of a semiconductor based power switching device in an AC power line, corruption of communications data or failure of such data to propagate through the device is avoided by ensuring that communication is only attempted (i.e. by coupling communications data on to the power line) during periods within the power cycle when the power switching device conduction status supports the propagation of communications data. Transmission of communications data by coupling such data on to the AC power line is therefore synchronised with the AC power waveform.

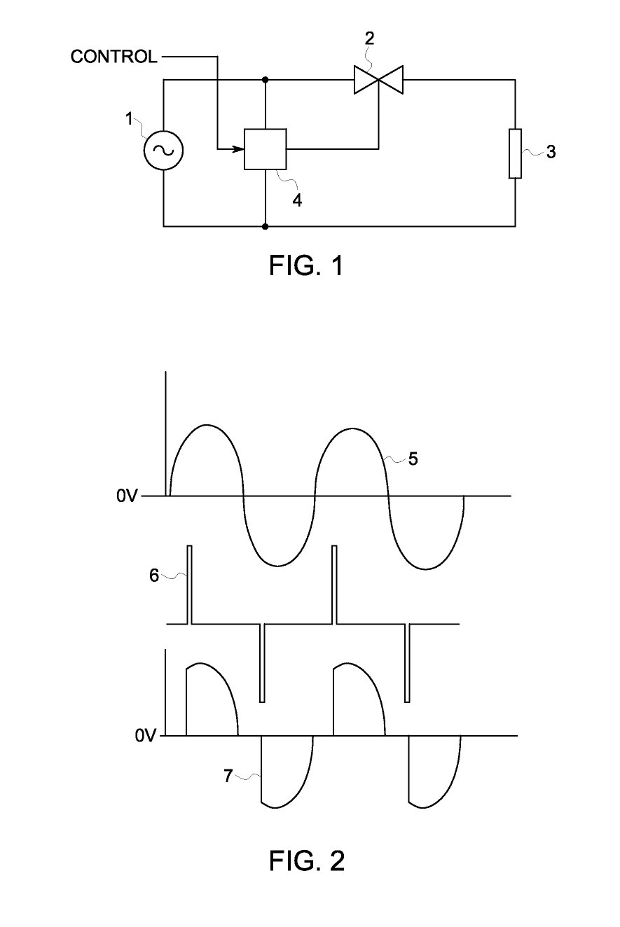

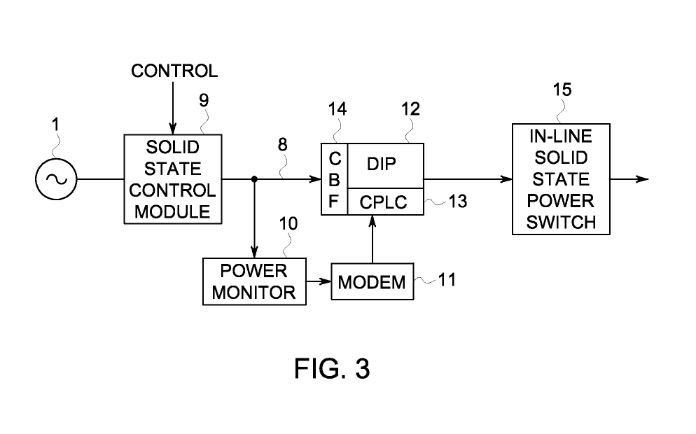

FIG. 3 illustrates, diagrammatically, an embodiment of the invention. The power source 1 feeds a power line 8 including a solid state control module 9, consisting of a semiconductor based switching device and trigger control circuitry, e.g. as items 2 and 4 of FIG. 1. An electronic monitoring module 10, monitors, by continuous sampling or otherwise, the AC power line voltage and current at the output from module 9 and creates windows for communication during positive and negative half cycles when the switching device in module 9 is switched on to a state where it transmits power to the output. The output from the module 10 is a “gating” signal that connects to a modem 11, which under the control of this gating signal, only couples communications data on to the power line after module 9 during such power conduction windows. Communications data from modem 11 is coupled on to the power line 8 via a diplexer (DIP) 12, the diplexer including a communications power line coupler (CPLC) 13 and a communications blocking filter (CBF) 14 for preventing communications data from being fed back towards source 1. The COP data from diplexer 12 is typically applied for use via an in-line solid state semiconductor based power switch 15. Thus, communication transmissions are restricted to “burst” operations during the states when the switching device in module 9 is switched on, i.e. within the positive and negative power conduction cycles. This technique therefore avoids trying to propagate communications data through a subsequent, downstream semiconductor based power switching device, during zero voltage and current crossings or during partial conduction states, which can result in transmission failure or data corruption.

By virtue of the synchronization of communications data with power, power switch 15 can be a simple solid state switch without the need to remove communications data from COP data before the switch and reintroduce that data on to the power line after the switch.

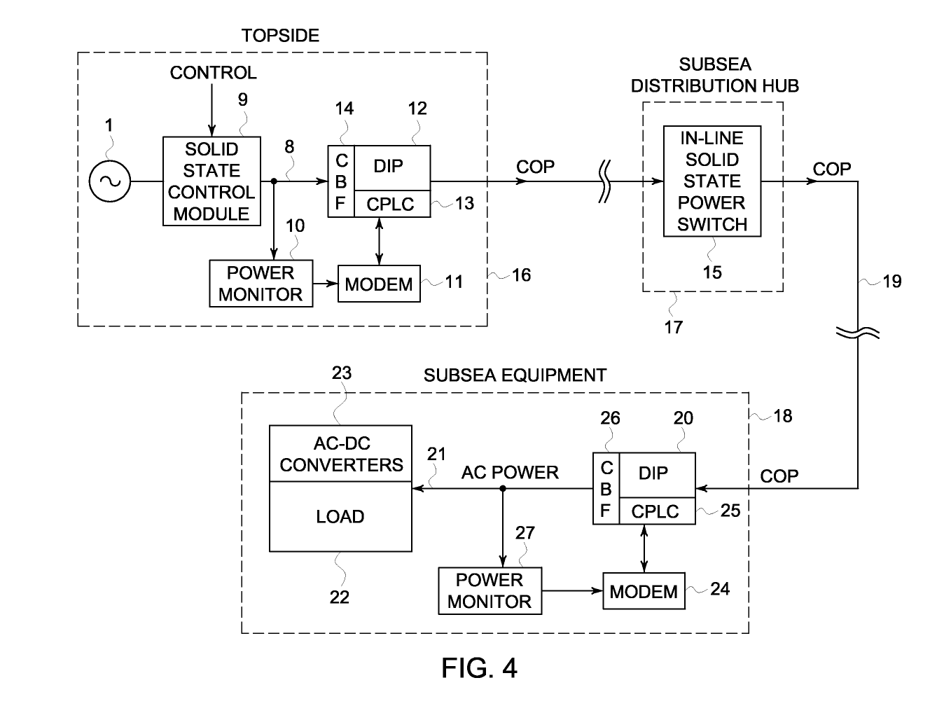

Referring to FIG. 4, this shows, in block diagrammatic form, a power supply and communications system of a subsea fluid extraction well complex. In topside equipment 16 there are items 1, 8, 9, 10, 11, 12, 13 and 14 of circuitry according to FIG. 3, the COP data from DIP 12 being sent down an umbilical to a subsea distribution hub 17 in which there is an in-line solid side state semiconductor based power switch 15. Depending on the overall system, there could be more than one such power switch 15, each respectively in-line with DIP 12. Switch 15 switches COP data to subsea equipment 18 via a connection 19, typically there being a long offset distance between hub 17 and equipment 18.

In subsea equipment 18, there is a diplexer 20 which receives the COP data and which passes AC power on a line 21 to a load 22 which typically could include AC to DC converters 23. The extraction of communications data from the COP data input to diplexer 20 is achieved by a modem 24, which extracts communications data from diplexer 20 via its communications power line coupler 25 (this occurring only during the positive and negative half cycles of the power on line 21). The diplexer 20 also comprises a communications blocking filter 26 to prevent communications data being passed to line 21. Under the control of an AC power monitoring and synchronization module 27, modem 24 can send communications data up to the topside equipment for extraction by modem 11, module 27 causing synchronization of the transmission of such data to the positive and negative half cycles of the power on line 21.

As well as enabling improved coupling of communications data on to a power line through a switching device using solid state semiconductor based power control techniques, embodiments of the present invention enable the removal of the need, in a COP system, to remove that data from a power line prior to a further semiconductor based power switching device and re-apply it after that device.

What is claimed is:

1. AC power supply circuitry comprising:
an AC power source;
a semiconductor switching device in an AC power line between the power source and an output;
a switch that switches the semiconductor switching device between a first state in which it transmits power from the source to the output and a second state in which it does not transmit power to the output; and
a diplexer that couples communications data on to the power line,
wherein communications data is coupled on to the power line only if said semiconductor device is in said first state.

2. Circuitry according to claim 1, wherein said causing means is arranged for monitoring power at said output for determining whether said semiconductor switching device is in said first state for controlling said coupling means.

3. Circuitry according to claim 1, wherein said switch is configured to switch said semiconductor switching device alternately between said first and second states.

4. Circuitry according to claim 3, wherein the periods in which said semiconductor switching device is in said first and second states are variable.

5. Circuitry according to claim 1, wherein said switch provides an electrical pulse to switch said semiconductor switching device between said first and second states.

6. Circuitry according to claim 5, wherein said switch provides a train of electrical pulses for switching said semiconductor switching device between said states.

7. Circuitry according to claim 1, wherein said semiconductor switching device is in said power line between said diplexer and said AC power source.

8. Circuitry according to claim 1, further comprising a further semiconductor switching device coupled with said power line and configured to receive power and communications data which has been coupled on to said power line.

9. Circuitry according to claim 1, further comprising a power and communications supply in a subsea fluid extraction well complex.

10. Circuitry according to claim 11, wherein said AC power source, said semiconductor switching device and said diplexer are located in topside equipment.

11. Circuitry according to claim 10, wherein said power and communications supply in the subsea fluid extraction well complex are configured to:
receive power and communications data from said power line;
extract received communications data; and
pass supplied power to a load.

12. Circuitry according to claim 11, further comprising a further semiconductor switching device coupled with said power line and configured to receive power and communications data which has been coupled on to said power line, wherein power and communications supply in the subsea fluid extraction well complex receives power and communications data from said further semiconductor switching device.

13. Circuitry according to claim 12, wherein said further semiconductor switching device is located subsea.
